(19) United States
(12) Patent Application Publication
(10) Pub. No.: US 2023/0080051 A1
(43) Pub. Date: Mar. 16, 2023

(54) OPTICAL NETWORK CABLE

(71) Applicant: WINGCOMM Co. Ltd., Jiangsu Province (CN)

(72) Inventors: Shuang Sun, Nantong (CN); Zuodong Wang, Beijing (CN); Wei Mao, Palo Alto, CA (US); Yun Bai, Beijing (CN)

(21) Appl. No.: 17/677,304

(22) Filed: Feb. 22, 2022

(30) Foreign Application Priority Data
Sep. 10, 2021 (CN) 202111059472.0

(51) Int. Cl. H04Q 11/00; H04L 12/54

(52) U.S. Cl. CPC H04Q 11/0067; H04L 12/5601; H04L 2012/5605; H04L 2012/5672

(57) ABSTRACT

Systems and methods that implement that an optical Ethernet cable compatible with an RJ45 Ethernet interface are described. One aspect includes a liner transmitter that linearly amplifies a first electrical Ethernet networking signal received from a network device via an RJ45 Ethernet interface. A laser diode converts the linearly amplified first electrical Ethernet networking signal into a first optical Ethernet networking signal and transmits the first optical Ethernet networking signal over a first optical communication channel. A photodetector receives a second optical Ethernet networking signal over a second optical communication channel and converts the second optical Ethernet networking signal to a second electrical Ethernet networking signal. A linear receiver receives the second electrical Ethernet networking signal, linearly amplifies the second electrical Ethernet networking signal, and transmits the linearly amplified second electrical Ethernet networking signal to the network device via the RJ45 Ethernet interface.

### CROSS-REFERENCE TO RELATED APPLICATION

This application claims the benefit of Chinese Application Serial No. 202111059472.0, filed Sep. 10, 2021, which is hereby incorporated herein by reference in its entirety.

### BACKGROUND

### Technical Field

The present disclosure relates to systems and methods that implement an optical Ethernet cable that is compatible with an RJ45 Ethernet interface.

### Background Art

With the rise of 5G, big data, distributed storage, artificial intelligence (AI) and high-speed computing services, the scale of data centers is growing day by day. The demand for transmission of high-bandwidth data is increasing, along with the requirements for network cables.

Currently available network cables include CAT.5E, CAT.6, CAT.6A, CAT.7, and CAT.8 cables. A network cable typically has a bandwidth rate of 1000 Mbps and a transmission distance of 100 m. Such a cable may be used in applications such as Ethernet networking for a home. This cable may be a shielded or unshielded network cable, which is mainly used for home and small office. The CAT.6 network cable has a bandwidth rate of 1000 Mbps and a transmission distance of 100 m. This cable type may be a shielded or and unshielded network cable. Such cables are mainly used in buildings and industries. The CAT.6A network cable has a bandwidth rate of 10 Gbps and a transmission distance of 100 m, the cable type may be a shielded or an unshielded network cable. Such cables are mainly used in data centers and broadband intensive applications. The CAT.7 network cable has a bandwidth rate of 10 Gbps and a transmission distance of 100 m. This cable type may be a shielded network cable, mainly being used in data centers and broadband-intensive applications. The CAT.8 network cable has a bandwidth rate of 25 Gbps and 40 Gbps, and a transmission distance of 30 m. The cable type may be a shielded network cable, mainly being used for data centers and broadband-intensive applications.

### SUMMARY

Aspects of the invention are directed to systems and methods for implementing an optical Ethernet cable that is compatible with an RJ45 Ethernet interface.

One apparatus includes a linear transmitter configured to receive a first electrical Ethernet networking signal from a network device via an RJ45 Ethernet interface. The linear transmitter may linearly amplify the first electrical Ethernet networking signal. The apparatus may include a laser diode configured to convert the amplified first electrical Ethernet networking signal into a first optical Ethernet networking signal, and transmit the first optical Ethernet networking signal over a first optical communication channel.

The apparatus may include a photodetector configured to receive a second optical Ethernet networking signal over a second optical communication channel, convert the second optical Ethernet networking signal to a second electrical Ethernet networking signal. The apparatus may include a linear receiver configured to receive the second electrical Ethernet networking signal. The linear receiver may linearly amplify the second electrical Ethernet networking signal, and transmit the amplified second electrical Ethernet networking signal to the network device via the RJ45 Ethernet interface. Aspects include methods that implement the described apparatus.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of an optical interface.

FIG. 2 is a block diagram depicting an embodiment of an optical connector.

FIG. 3 is a block diagram depicting an embodiment of a signal chain.

FIG. 4 is a circuit diagram depicting an embodiment of a linear receiver amplifier interface.

FIG. 5 is a circuit diagram depicting an embodiment of a linear transmitter amplifier.

FIG. 6 is a flow diagram depicting a method to transmit an Ethernet networking signal.

FIG. 7 is a flow diagram depicting a method to receive an Ethernet networking signal.

FIG. 8 is a block diagram depicting an embodiment of a linear receiver.

FIG. 9 is a block diagram depicting an embodiment of a linear transmitter.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein address the limitations associated with copper-based RJ45 Ethernet networking cables. Such cables suffer from significant crosstalk and return losses because copper wire is used as a communication medium. Excessive return loss and crosstalk associated with a copper-based RJ45 network cable directly may result in an instability associated with network speed. Long-term use of inferior (e.g., copper-based) RF45 Ethernet networking cables may lead to a decrease in transmission rate. Or, the network may be frequently dropped and/or the network speed may not be not up to standard. The return loss and crosstalk of copper-based RJ45 Ethernet networking cables may be significant to the extent that the quality of data transmission may be significantly degraded. If copper-based RJ45 Ethernet network cables are used to transmit signals at a higher speed while maintaining data quality, these cables need thicker cores. Due to this, the cost of the network cables increases, and the volume occupied by the network cables becomes larger and larger, which makes wiring difficult. It is very difficult to use copper wires for transmission at speeds of 10G and higher.

Moreover, a copper-based RJ45 network cable is vulnerable to electromagnetic interference because it uses copper wire as the communication medium. In certain Electromagnetic Interference (EMI) and Radio Frequency Interference (RFI) environments such as motors, engines, or other machine accessories that can produce electronic interference, a copper-based network cable cannot work normally.

To address the above shortcomings of copper-based RJ45 Ethernet networking cables, an optical RJ45 Ethernet networking cable is described. In one embodiment, an optical RJ45 Ethernet networking cable (referred to herein as an “optical connector”) includes a bidirectional optical communication channel comprised of two opposite unidirectional optical communication channels.

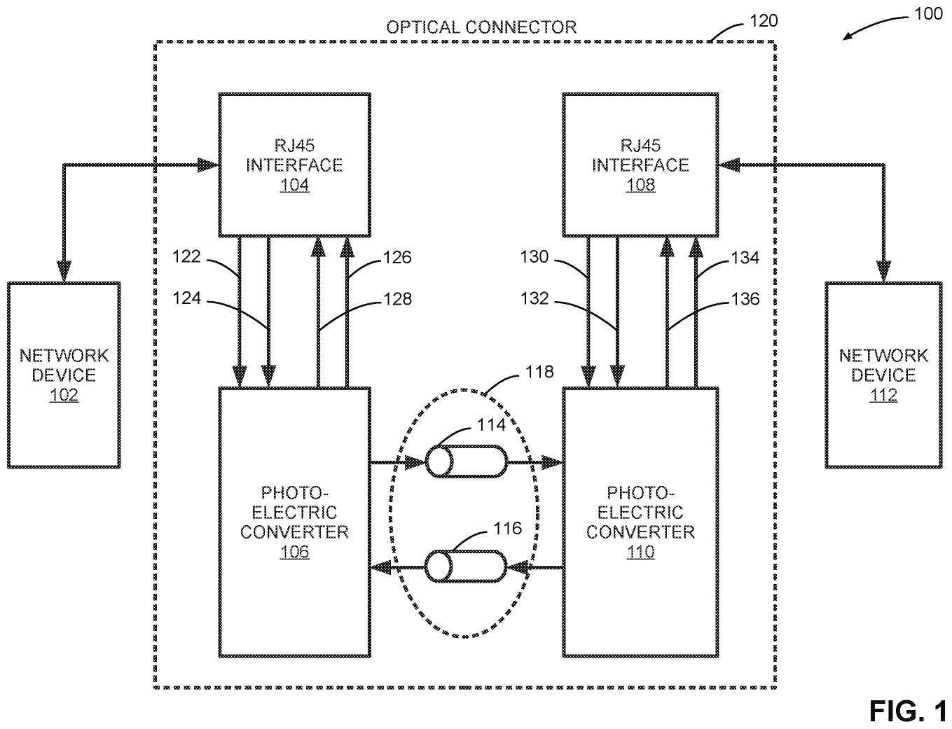

FIG. 1 is a block diagram depicting an embodiment of an optical interface 100. As depicted, optical interface 100 includes network device 102, optical connector 120, and network device 112. Optical connector 120 further includes RJ45 interface 104, photoelectric converter 106, bidirectional optical communication channel 118, photoelectric converter 110, and RJ45 interface 108. Bidirectional optical communication channel 118 further includes unidirectional optical communication channel 114 and unidirectional optical communication channel 116. Unidirectional optical communication channels 114 and 116 may be configured to transmit data in opposite directions. Each of unidirectional optical communication channel 114 and 116 may be comprised of one or more optical fibers.

In one aspect, each of RJ45 interface 104 and RJ45 interface 108 is a RJ45 male connector similar to an RJ45 male connector used in conventional copper-based RJ45 Ethernet cables. Each of network device 102 and network device 112 may be a computing device such as a laptop computer, a desktop computer, a server, or any similar computing system. It is generally understood that the term “computing device” is a device that includes a processor, a memory, and a network interface. Each of network device 102 and 112 may include an RJ45 Ethernet interface configured to mate with RJ45 interface 104 and RJ45 interface 108, respectively. In one aspect, the RJ45 Ethernet interface associated with network device 102 and 112 may be implemented as a female receptacle configured to mate with a male RJ45 connector (e.g., RJ45 interface 104 and 108).

In one aspect, optical connector 120 receives an electrical Ethernet networking signal from network device 102, via RJ45 interface 104. This electrical Ethernet networking signal may be a differential signal comprised of a TX+ signal 122 and a TX− signal 124. In one aspect, each of TX+ signal 122 and TX− signal 124 is an electrical signal.

Photoelectric converter 106 may be configured to receive TX+ signal 122 and TX− signal 124, and convert a combination of these signals into a first optical signal. This first optical signal is an optical Ethernet networking signal. To accomplish this conversion, photoelectric converter 106 may include one or more vertical-cavity surface-emitting lasers (VCSELs) or other types of lasers or light emitters. Photoelectric converter 106 can transmit the first optical signal to photoelectric converter 110 via unidirectional optical communication channel 114.

Photoelectric converter 110 may receive the first optical signal from photoelectric converter 106, and convert the first optical signal into a differential electrical signal pair comprising a RX+ signal 134 and an RX− signal 136. In one aspect, this conversion may be performed by one or more photodetectors (e.g., photodiodes). Photoelectric converter 110 can transmit RX+ signal 134 and RX− signal 136 to network device 112 via RJ45 interface 108. RX+ signal 134 and RX− signal 136 can be electrical Ethernet networking signals that are substantially similar (if not identical) to TX+ signal 122 and TX− signal 124.

In one aspect, optical connector 120 receives an electrical Ethernet networking signal from network device 112, via RJ45 interface 108. This electrical Ethernet networking signal may be a differential signal comprised of a TX+ signal 130 and a TX− signal 132. In one aspect, each of TX+ signal 130 and TX− signal 132 is an electrical signal.

Photoelectric converter 110 may be configured to receive TX+ signal 130 and TX− signal 132, and convert a combination of these signals into a second optical signal. This second optical signal is an optical Ethernet networking signal. To accomplish this conversion, photoelectric converter 110 may include one or more vertical-cavity surface-emitting lasers (VCSELs) or other types of lasers or light emitters. Photoelectric converter 110 can transmit the first optical signal to photoelectric converter 106 via unidirectional optical communication channel 116.

Photoelectric converter 106 may receive the second optical signal from photoelectric converter 110, and convert the second optical signal into a differential electrical signal pair comprising a RX+ signal 126 and an RX− signal 128. In one aspect, this conversion may be performed by one or more photodetectors (e.g., photodiodes). Photoelectric converter 106 can transmit RX+ signal 126 and RX− signal 128 to network device 102 via RJ45 interface 104. RX+ signal 126 and RX− signal 128 can be electrical Ethernet networking signals that are substantially similar (if not identical) to TX+ signal 130 and TX− signal 132.

Optical connector 120 is configured to implement a bidirectional Ethernet communication link between networking devices 102 and 112 via a bidirectional optical communication channel comprising unidirectional optical communication channels 114 and 116.

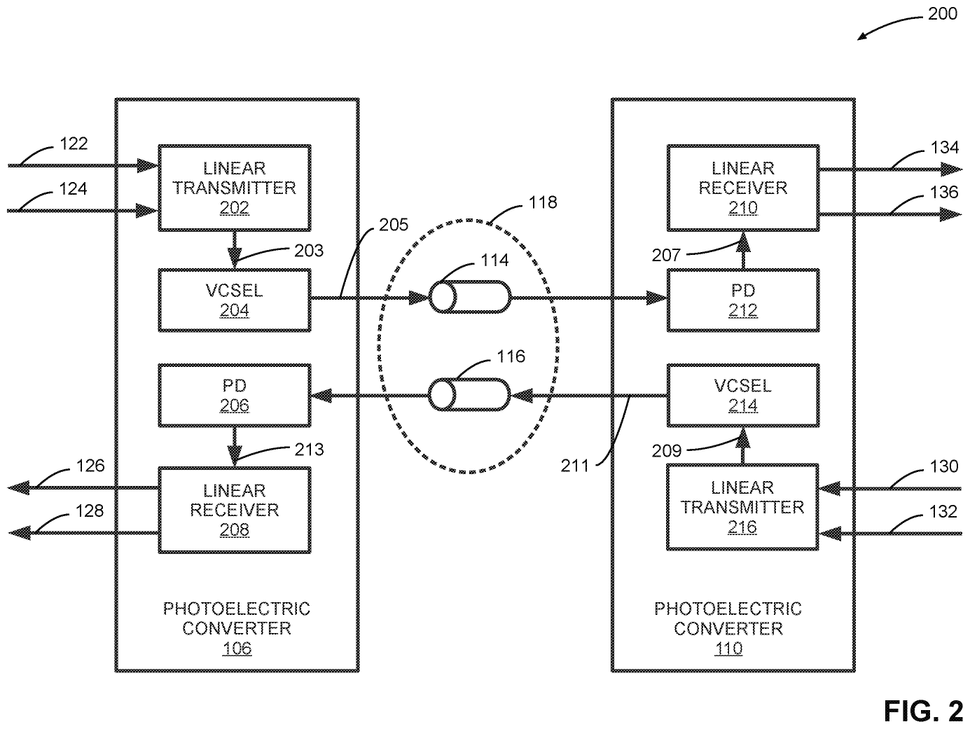

FIG. 2 is a block diagram depicting an embodiment of an optical connector 200. As depicted, optical connector includes photoelectric converter 106, photoelectric converter 110, and bidirectional optical communication channel 118. Photoelectric converter 106 further includes linear transmitter 202, vertical-cavity surface-emitting laser VCSEL 204, photodetector PD 206, and linear receiver 208. Photoelectric converter 110 further includes linear receiver 210, photodetector PD 212, vertical-cavity surface-emitting laser VCSEL 214, and linear transmitter 216. Bidirectional optical communication channel 118 further includes unidirectional optical communication channel 114 and unidirectional optical communication channel 116. In one aspect, optical connector 200 is similar (or essentially identical) to optical connector 120. FIG. 2 depicts additional internal structure detail of photoelectric converter 106 and of photoelectric converter 110.

In one aspect, linear transmitter 202 receives TX+ signal 122 and TX− signal 124 from RJ45 interface 104, and performs a linear amplification on these signals. A linearly amplified output signal 203 from linear transmitter 202 is transmitted to VCSEL 204, which converts the linearly amplified output signal into an optical signal 205. The optical signal 205 is transmitted over unidirectional optical communication channel 114 to PD 212. PD 212 converts the received optical signal received from VCSEL 204 into an electrical signal 207, and transmits this electrical signal to linear receiver 210. Linear receiver 210 performs a linear amplification on the electrical signal received from PD 212, and generates RX+ signal 134 and RX− signal 136, which are then transmitted to RJ45 interface 108.

In one aspect, linear transmitter 216 receives TX+ signal 130 and TX− signal 132 from RJ45 interface 108, and performs a linear amplification on these signals. A linearly amplified output signal 209 from linear transmitter 216 is transmitted to VCSEL 214, which converts the linearly amplified output signal into an optical signal 211. The optical signal 211 is transmitted over unidirectional optical communication channel 116 to PD 206. PD 206 converts the received optical signal received from VCSEL 214 into an electrical signal 213, and transmits this electrical signal to linear receiver 208. Linear receiver 208 performs a linear amplification on the electrical signal received from PD 206, and generates RX+ signal 126 and RX− signal 128, which are then transmitted to RJ45 interface 104. Photoelectric converter 106 may be architecturally and functionally similar to photoelectric converter 110.

In one aspect, VCSEL 204 and/or VCSEL 214 may be replaced by any combination of a distributed feedback (DFB) laser, a light emitting diode LED laser, a directly-modulated laser (DML), an electromagnetically modulated laser (EML), and so on.

Contemporary non-return to zero (NRZ) optical receivers and transmitters use limiting amplifiers and data clock recovery (CDR) for signal reception. Such an arrangement does not function properly with pulse-amplitude modulated (PAM) signals, since a PAM signal has multiple signal amplitude levels. If limiting amplifiers are used to perform limiting amplification on a PAM signal, the different signal amplitudes will be distorted after the limiting amplification. The larger the signal amplitude, the greater the distortion. Asymmetric data cutting can improve the linearity, but the improvement is limited. Incorporating linear transmitters 202 and 216, and linear receivers 208 and 210 in optical connector 200 allows signals with different amplitudes (e.g., PAM signals) to be linearly amplified. This further enables optical connector 200 to be compatible with data of various NRZ and PAM formats and various Ethernet data coding formats. Optical connector 200 may also be compatible with various low-speed and high-speed rates, and can transmit higher rates than copper wires without causing data distortion, thereby greatly improving the sensitivity of receiving data links.

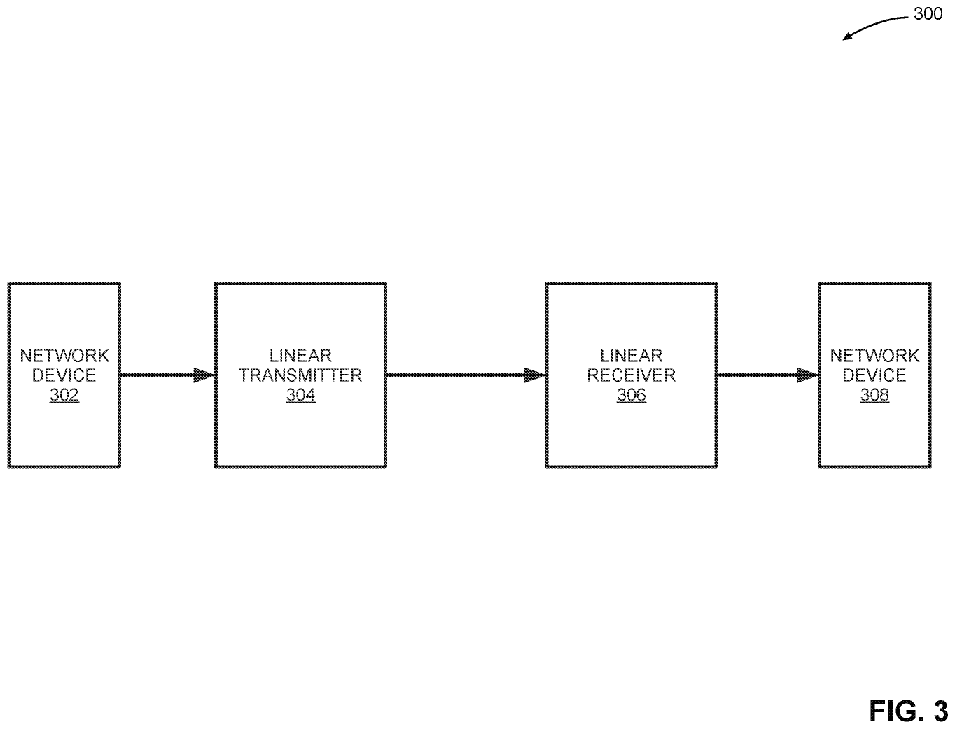

FIG. 3 is a block diagram depicting an embodiment of a signal chain 300. As depicted, signal chain includes network device 302, linear transmitter 304, linear receiver 306, and network device 308. Signal chain 300 depicts a unidirectional data transmission path from network device 302 to network device 308. Signal 300 may represent a signal transmission from network device 102 to network device 112, or vice versa. Signals transmitted by network device 302 may include Ethernet coding signals such as NRZ, PAM3, PAM4, PAM5, PAM16, etc., as well as 100BASE-T1, 100BASE-T4, 1000BASE-T1, 2.5GBASE-T, 5GBASE-T, 10GBASE-T, 25GBASE-T, 50GBASE-T, 10BASE-T, 100BASE-T2, 1000BASE-T and other IEEE network standards.

In one aspect, an Ethernet networking signal transmitted by network device 302 may be received via an RJ 45 interface such as RF45 interface 104 or 108. This Ethernet networking signal may be a differential electrical signal comprised of a TX+ signal and a TX− signal (e.g., TX+ signal 122 and TX− signal 124, or TX+ signal 132 and TX− signal 134). This differential electrical signal may be linearly amplified by linear transmitter 304. The linearly amplified signal may be converted into an optical signal by a laser diode (e.g., VCSEL 204 or 214, not shown in FIG. 3). The optical signal is transmitted via an optical communication channel (e.g., unidirectional optical communication channel 114 or 116), to a photodetector (e.g., PD 212 or 206, not depicted in FIG. 3). The photodetector converts the received optical signal to an electrical signal, and transmits the electrical signal to linear receiver 306. Linear receiver 306 may be similar to linear receiver 210 or 208. Linear receiver 306 performs linear amplification on the input electrical signal, to produce a differential electrical signal comprising an RX+ signal and an RX− signal (e.g., RX+ signal 134 and RX− signal 136, or RX+ signal 126 and RX− signal 128). This differential electrical signal is transmitted to network device 108 via an RJ45 interface, (e.g., RJ45 interface 108 or 104).

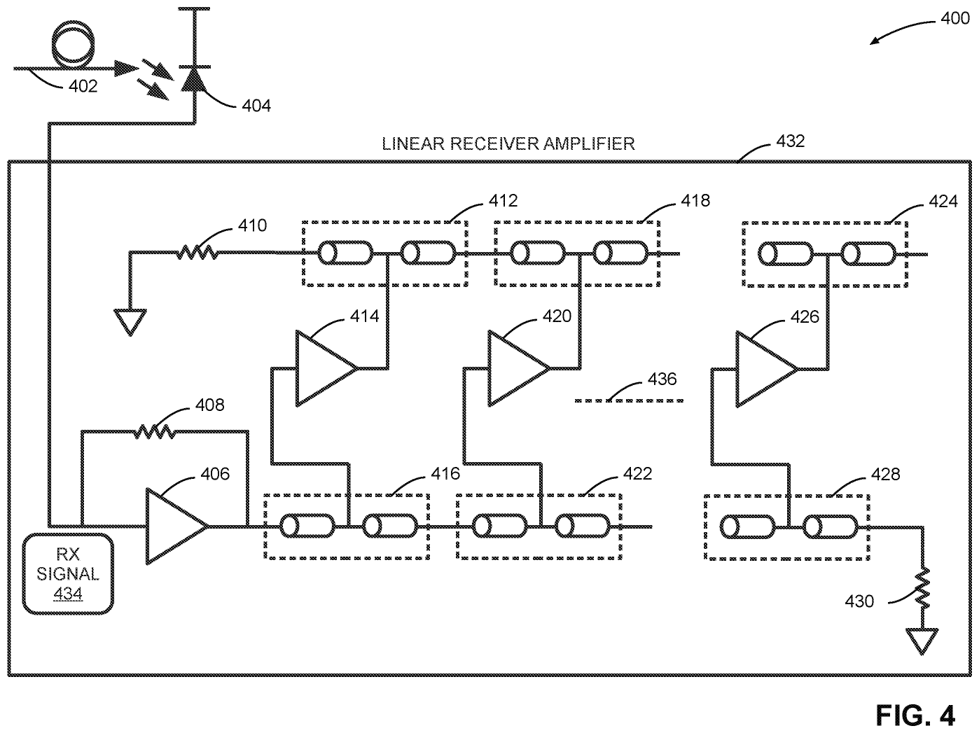

FIG. 4 is a circuit diagram depicting an embodiment of a linear receiver amplifier interface 400. As depicted, linear receiver amplifier interface 400 includes unidirectional optical communication channel 402, photodetector 404, and linear receiver amplifier 432. Linear receiver amplifier 432 further includes transimpedance amplifier 406, parallel resistor 408, termination resistor 410, transmission line 416 connected to an output of transimpedance amplifier 406 and to an input of amplifier 414, transmission line 412 connected to an output of amplifier 414, transmission line 422 connected to transmission line 416 and to an input of amplifier 420, transmission line 418 connected to transmission line 412 and to an output of amplifier 420, transmission line 428 connected to a preceding transmission line and to an input of amplifier 426. Amplifiers and transmission lines are cascaded in a chain 436, with chain 436 ending in transmission line 424 connected to a preceding transmission line and to an output of amplifier 426, and to termination resistor 430.

In one aspect, linear receiver amplifier 432 is a component of linear receiver 208 and/or 210. As depicted, transmission line 412, amplifier 414 and transmission line 416 comprise a first amplifier stage; transmission line 418, amplifier 420 and transmission line 422 comprise a second amplifier stage; and so on, with transmission line 424, amplifier 426 and transmission line 428 comprising an N^{th} amplifier stage. Collectively, these N amplifier stages, transimpedance amplifier 406, and associated resistive circuitry (i.e., resistors 408, 410, and 430) comprise a distributed linear transimpedance amplifier that linearly amplifies an input signal to transimpedance amplifier 406. In other words, linear receiver amplifier 432 functions as a distributed linear transimpedance amplifier. An advantage of a distributed linear transimpedance amplifier is that such an amplifier provides a wide frequency range (i.e., a large bandwidth) and a high gain. This is advantageous for maintaining signal integrity when performing PAM signaling.

In one aspect, photodetector 404 receives an optical Ethernet networking signal via unidirectional optical communication channel 402. For example, photodetector 404 and unidirectional optical communication channel 402 may be similar to PD 212 and unidirectional optical communication channel 114, or PD 206 and unidirectional optical communication channel 116, respectively. Photodetector 404 may be configured to convert the optical Ethernet networking signal into an RX signal 434. In one aspect, RX signal 434 is an electrical Ethernet networking signal.

In one aspect, amplifier 406 amplifies RX signal 434, to produce an amplified RX signal. This amplified signal is successively amplified by the N amplifier stages that individually and collectively provide gain compensation to this signal. An output of the N^{th} amplifier stage is a gain compensated signal (e.g., a linearly amplified version of RX signal 434 output by transmission line 424) that is transmitted to an associated downstream network device via an RJ45 connector. For example, the gain compensated signal may be transmitted from linear receiver 210 to network device 112 via RJ45 interface 108. Or, the gain compensated signal may be transmitted from linear receiver 208 to network device 102 via RJ45 interface 104.

In one aspect, linear receiver amplifier 432 further includes termination resistor 410 and termination resistor 430. One end of termination resistor 410 is grounded, and the other end is connected to transmission line 412. One end of termination resistor 430 is grounded, and the other end is connected to transmission line 428. Termination resistor 410 may be configured to provide impedance matching with transmission lines 412, 418, through 424. Termination resistor 430 may be configured to provide impedance matching with transmission lines 416, 422, through 428.

Parallel resistor 408 may be connected in parallel with transimpedance amplifier 406. Parallel resistor 408 may be configured to convert input current to voltage. Negative feedback provided through amplifier 406 and parallel resistor 408 can create a low input impedance, thus achieving a high bandwidth.

As depicted, the input and output of each of amplifiers 414, 420, through 426 are connected to transmission lines for impedance matching. Specifically, amplifier 414 is connected to transmission lines 416 and 412, amplifier 420 is connected to transmission lines 422 and 418, and so on, with amplifier 426 being connected to transmission lines 428 and 424. In one aspect, transimpedance amplifier 406 (also referred to as a “linear transimpedance amplifier”) injects input signals into each of amplifier 414 through 426, via the transmission lines 416 through 428, respectively. An output of each of amplifier 414 through 416 is collected and superimposed by transmission lines 412 through 424 respectively, to produce a linearly amplified output signal.

In one aspect, each of amplifier 414, 420, through 426 provides a gain of about 1 dB, and each gain stage can work at a frequency of 25 GHZ above. Compared with a traditional cascaded gain amplifier design, the total gain of linear receiver amplifier 432 can be unchanged, but the associated bandwidth can be improved significantly. The transmission line of the distributed linear transimpedance amplifier is equivalent to an inductance, which can offset the parasitic capacitance of the amplifier unit, so the distributed linear transimpedance amplifier has a high bandwidth.

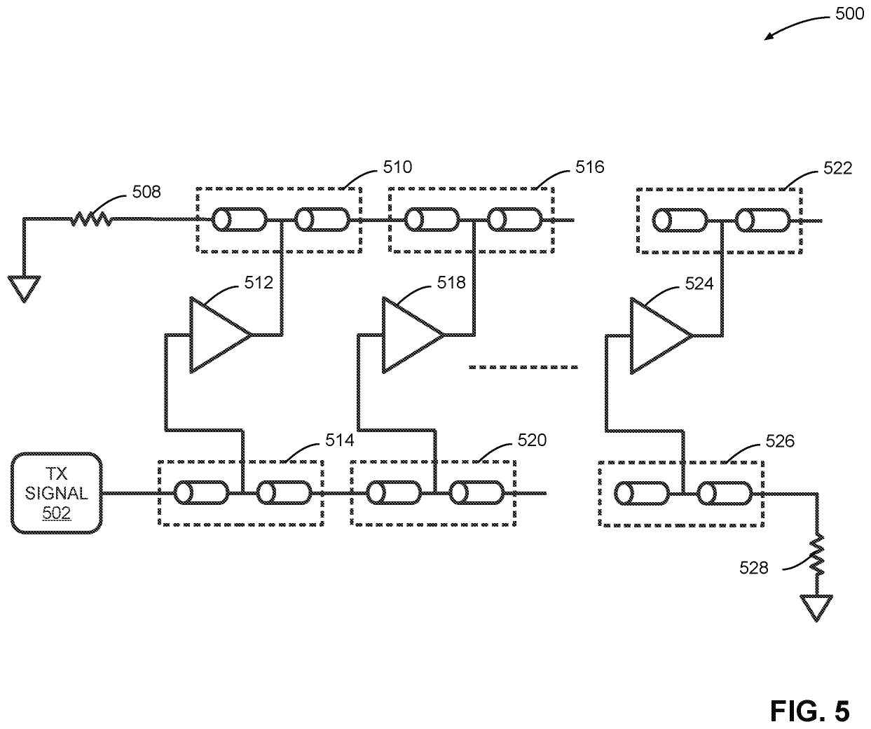

FIG. 5 is a circuit diagram depicting an embodiment of a linear transmitter amplifier 500. As depicted, linear transmitter amplifier 500 further includes termination resistor 508, transmission line 514 connected to an input of amplifier 512, transmission line 510 connected to an output of amplifier 512, transmission line 520 connected to transmission line 514 and to an input of amplifier 518, transmission line 516 connected to transmission line 510 and to an output of amplifier 518, transmission line 526 connected to a preceding transmission line and to an input of amplifier 524, transmission line 522 connected to a preceding transmission line and to an output of amplifier 524, and termination resistor 528.

In one aspect, linear transmitter amplifier 500 is a component of linear transmitter 202 and/or 216. As depicted, transmission line 514, amplifier 512 and transmission line 510 comprise a first amplifier stage; transmission line 520, amplifier 518 and transmission line 516 comprise a second amplifier stage; and so on, with transmission line 526, amplifier 524 and transmission line 522 comprising an N^{th} amplifier stage. Collectively, these N amplifier stages, and associated resistive circuitry (i.e., resistors 508, and 528) comprise a distributed linear transimpedance amplifier that linearly amplifies an input signal TX signal 502 to amplifier 512 via transmission line 514. In other words, linear transmitter amplifier 500 provides voltage amplification. An advantage of linear transmitter amplifier 500 is that such an amplifier provides a wide frequency range (i.e., a large bandwidth) and a high gain. This is advantageous for maintaining signal integrity when performing PAM signaling.

In one aspect, TX signal 502 is an electrical Ethernet networking signal received from network device 102 or 112, via RJ45 interface 104 or 108, respectively. TX signal 502 may be successively amplified by the N amplifier stages that individually and collectively provide gain compensation to this signal. An output of the N^{th} amplifier stage is a gain compensated signal (e.g., a linearly amplified version of RX signal 434 output by transmission line 424) that is transmitted to a laser diode for conversion into an optical Ethernet networking signal. For example, the gain compensated signal may be transmitted from linear transmitter 202 to VCSEL 204. Or, the gain compensated signal may be transmitted from linear transmitter 216 to VCSEL 214.

In one aspect, linear transmitter amplifier 500 further includes termination resistor 508 and termination resistor 528. One end of termination resistor 508 is grounded, and the other end is connected to transmission line 510. One end of termination resistor 528 is grounded, and the other end is connected to transmission line 526. Termination resistor 508 may be configured to provide impedance matching with transmission lines 510, 516, through 522. Termination resistor 528 may be configured to provide impedance matching with transmission lines 514, 520, through 526.

As depicted, the input and output of each of amplifiers 512, 518, through 524 are connected to transmission lines for impedance matching. Specifically, amplifier 512 is connected to transmission lines 514 and 510, amplifier 518 is connected to transmission lines 520 and 516, and so on, with amplifier 524 being connected to transmission lines 526 and 522. In one aspect, TX signal 502 is input to each of amplifier 514 through 524, via the transmission lines 514 through 526, respectively. An output of each of amplifier 512 through 524 is collected and superimposed by transmission lines 510, through 522 respectively, to produce a linearly amplified output signal.

In one aspect, each of amplifier 512, 518, through 524 provides a gain of about 1 dB, and each gain stage can work at a frequency of 25 GHZ above. Compared with a traditional cascaded gain amplifier design, the total gain of linear transmitter amplifier 500 can be unchanged, but the associated bandwidth can be improved significantly. The transmission line of linear transmitter amplifier 500 is equivalent to an inductance, which can offset the parasitic capacitance of the amplifier unit, so linear transmitter amplifier 500 has a high bandwidth.

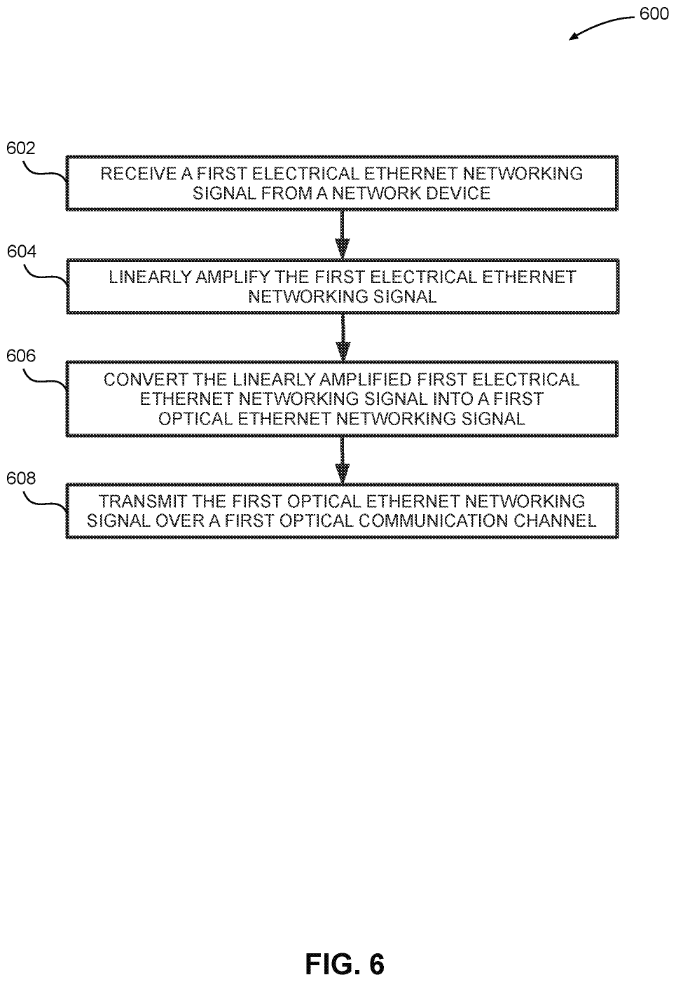

FIG. 6 is a flow diagram depicting a method 600 to transmit an Ethernet networking signal. Method 600 may include receiving a first electrical Ethernet networking signal from a network device (602). For example, photoelectric converter 106 (specifically, linear transmitter 202) may receive a differential Ethernet networking signal comprised of a TX+ signal 122 and a TX− signal 124, from network device 102. Or, photoelectric converter 106 (specifically, linear transmitter 216) may receive a differential Ethernet networking signal comprised of a TX+ signal 130 and a TX− signal 132, from network device 112.

Method 600 may include linearly amplifying the first electrical Ethernet networking signal (604). For example, linear transmitter 202 or 216 may linearly amplify a received electrical Ethernet networking signal.

Method 600 may include converting the linearly amplified first electrical Ethernet networking signal into a first optical Ethernet networking signal (606). For example, VCSEL 204 may convert an output of linear transmitter 202 into an optical Ethernet networking signal. Or, VCSEL 214 may convert an output of linear transmitter 216 into an optical Ethernet networking signal.

Method 600 may include transmitting the first optical Ethernet networking signal over a first optical communication channel (608). For example, VCSEL 204 may transmit an associated optical Ethernet networking signal over unidirectional optical communication channel 114. Or, VCSEL 214 may transmit an associated optical Ethernet networking signal over unidirectional optical communication channel 116.

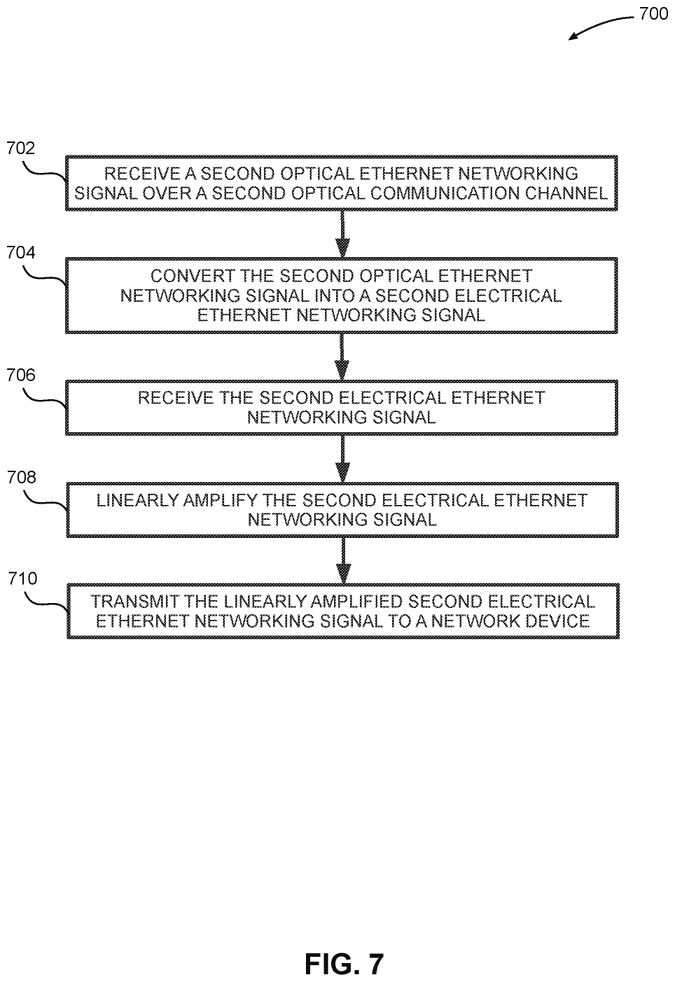

FIG. 7 is a flow diagram depicting a method 700 to receive an Ethernet networking signal. Method 700 may include receiving a second optical Ethernet networking signal over a second optical communication channel (702). For example, photoelectric converter 106 (specifically, PD 206) may receive an optical Ethernet networking signal (e.g., optical signal 205) over unidirectional optical communication channel 116. Or, photoelectric converter 11 (specifically, PD 212) may receive an optical Ethernet networking signal (e.g., optical signal 211) over unidirectional optical communication channel 114.

Method 700 may include converting the second optical Ethernet networking signal into a second electrical Ethernet networking signal (704). For example, PD 206 may convert a received optical Ethernet networking signal into a corresponding electrical Ethernet networking signal. Or, PD 212 may convert a received optical Ethernet networking signal into a corresponding electrical Ethernet networking signal.

Method 700 may include receiving the second electrical Ethernet networking signal (706). For example, linear receiver 208 may receive an electrical Ethernet networking signal from PD 206. Or, linear receiver 210 may receive an electrical Ethernet networking signal from PD 212.

Method 700 may include linearly amplifying the second electrical Ethernet networking signal (708). For example, linear receiver 208 or 210 may linearly amplify a received electrical Ethernet networking signal received from PD 206 or 212, respectively.

Method 700 may include transmitting the linearly amplified second electrical Ethernet networking signal to a network interface (710). For example, linear receiver 208 may transmit a linearly amplified electrical Ethernet networking signal to network device 102 via RJ45 interface 104. Or, linear receiver 210 may transmit a linearly amplified electrical Ethernet networking signal to network device 112 via RJ45 interface 108.

In one aspect, optical connector 120 is an active network cable that needs a power supply to operate. Different embodiments of optical connector 120 may have any combination of the following (and other) power supply options:

1. Each end (i.e., connecting terminal) of optical connector 120 (to include photoelectric converter 106 and 110) may be designed to include a USB interface, and power may be supplied to the respective components (e.g., photoelectric converter 106 and 110) via the corresponding USB interface.

2. Optical connector 120 may be connected with an AC to DC power converter. A common AC-to-DC power converter may be used for supplying power to optical connector 120. The DC-DC through optical connector 120 may be converted into a workable voltage consistent with circuitry included in optical connector 120.

3. The power supply may be obtained by adding magnetic bead filtering to some or all signal lines TX+, TX−, RX+ and RX− of optical connector 120. In this case, there is no need to set an additional power supply interface. Because the signal lines not only transmits AC signals but also transmit DC signals, after adding magnetic beads or inductors to the TX+, TX−, RX+, RX− signal lines, the AC signal will be filtered out, and the filtered DC signal can supply power to optical connector 120.

In one aspect, the network device 102 is a router or a switch; and network device 112 is a networked terminal. In another aspect, network device 102 is a networked terminal; and network device 112 is a control device.

Optical connector 120 may be used to replace the existing common network cable. It can be used for interconnection between routers/switches and networked terminal devices, and also for interconnection between networked terminal devices and control devices.

Optical connector 120 may be used in implementing interconnections in networks such as 100-megabit networks and gigabit networks. Optical connector 120 can also be used in applications with high-speed transmission and high bandwidth requirements, such as video conferencing, streaming media broadcast, voice phone based on network, grid computing and storage network. Because this high-speed network cable can adapt to 10/100/1000/10GBASE-T Ethernet data transmission, it can also be widely used in indoor high-demand horizontal wiring. Because of its strong anti-interference ability, the network cable is suitable for the wiring of shielded computer room and secure network.

A traditional network cable is typically a twisted pair, which consists of one or more pairs of wires that collectively form a data transmission line. The twisted pair is generally formed by winding insulated copper wires. Twisted-pair transmission distance, channel width, and data transmission speed are limited to some extent. In contrast, optical connector 120 transmits data through an optical fiber instead of a copper wire, and because the signals are transmitted by light wave(s), optical connector 120 has strong anti-electromagnetic interference capability, good confidentiality (with respect to snooping of electromagnetic signals, for example), high speed, large transmission capacity and longer transmission distance.

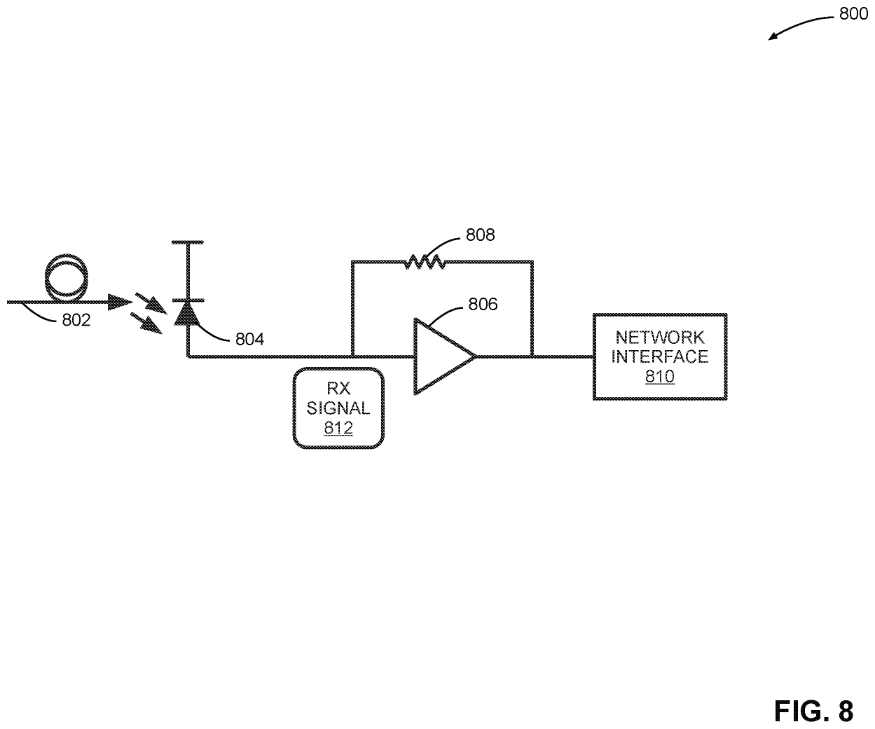

FIG. 8 is a block diagram depicting an embodiment of a linear receiver 800. As depicted, linear receiver 800 includes unidirectional optical communication channel 802, photodetector 804, transimpedance amplifier 806, parallel resistor 808, and network interface 810. In one aspect, linear receiver 800 is a component of or is used to implement linear receiver 208 and/or 210.

In one aspect, photodetector 804 receives an optical Ethernet networking signal via unidirectional optical communication channel 802. For example, photodetector 804 and unidirectional optical communication channel 802 may be similar to PD 212 and unidirectional optical communication channel 114, or PD 206 and unidirectional optical communication channel 116, respectively. Photodetector 804 may be configured to convert the optical Ethernet networking signal into an RX signal 812. In one aspect, RX signal 812 is an electrical Ethernet networking signal.

In one aspect, amplifier 806 amplifies RX signal 812, to produce an amplified RX signal. In one aspect, a combination of amplifier 806 and parallel resistor 808 functions as a linear transimpedance amplifier that performs linear amplification on RX signal 812. Parallel resistor 808 may be configured to convert input current associated with RX signal 812 to a voltage. Negative feedback provided through amplifier 806 and parallel resistor 808 can create a low input impedance, thus achieving a high bandwidth. In one aspect, the amplified RX signal output by amplifier 806 is transmitted to network interface 810 that may be similar to RJ45 interface 108 or 104.

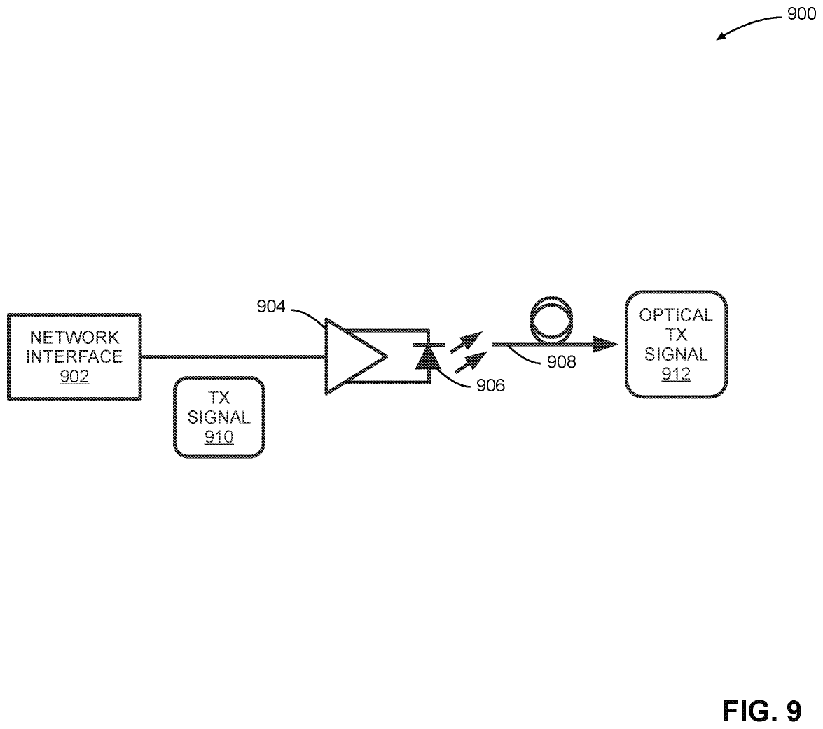

FIG. 9 is a block diagram depicting an embodiment of a linear transmitter 900. As depicted, linear transmitter includes network interface 902, linear driver 904, laser diode 906, and unidirectional optical communication channel 908. In one aspect, linear transmitter 900 is a component of or is used to implement linear transmitter 202 and/or 216.

In one aspect, TX signal 910 is an electrical Ethernet networking signal received from network device 102 or 112, via network interface 902. Network interface 902 may be identical to RJ45 interface 104 or 108, respectively. TX signal 902 may be linearly amplified by linear driver 904. An amplified TX signal output by linear driver 904 is converted into an optical TX signal 912, and transmitted via unidirectional optical communication channel 908. Laser diode 906 and unidirectional optical communication channel 908 may be similar to VCSEL 204 and unidirectional optical communication channel 114, or VCSEL 214 and unidirectional optical communication channel 116, respectively.

In one aspect, laser diode 906 may be implemented using any of a distributed feedback (DFB) laser, a light emitting diode LED laser, a directly-modulated laser (DML), an electromagnetically modulated laser (EML), and so on.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. An apparatus comprising:
a linear transmitter configured to:
receive a first electrical Ethernet networking signal from a network device via an RJ45 Ethernet interface; and
linearly amplify the first electrical Ethernet networking signal;
a laser diode configured to:
convert the linearly amplified first electrical Ethernet networking signal into a first optical Ethernet networking signal; and
transmit the first optical Ethernet networking signal over a first optical communication channel;
a photodetector configured to:
receive a second optical Ethernet networking signal over a second optical communication channel; and
convert the second optical Ethernet networking signal to a second electrical Ethernet networking signal; and
a linear receiver configured to:
receive the second electrical Ethernet networking signal;
linearly amplify the second electrical Ethernet networking signal; and
transmit the linearly amplified second electrical Ethernet networking signal to the network device via the RJ45 Ethernet interface.

2. The apparatus of claim 1, wherein the linear receiver includes a linear transimpedance amplifier.

3. The apparatus of claim 1, wherein the linear receiver includes a distributed linear transimpedance amplifier.

4. The apparatus of claim 3, wherein the distributed linear transimpedance amplifier is comprised of:
a transimpedance amplifier connected to the first transmission line and configured to perform linear amplification on an electrical Ethernet networking signal;
a first transmission line connected to an output of the transimpedance amplifier;
an amplifier unit to receive an amplified electrical Ethernet signal from the transimpedance amplifier via the first transmission line and provide a gain compensation to the amplified electrical Ethernet networking signal; and
a second transmission line configured to receive the gain-compensated electrical Ethernet networking signal from the amplifier unit and provide an impedance matching function for the gain-compensated electrical Ethernet networking signal.

5. The apparatus of claim 3, wherein the distributed linear transimpedance amplifier includes a plurality of cascaded amplifier stages.

6. The apparatus of claim 1, wherein the linear transmitter includes a linear amplifier configured to perform linear amplification on the first electrical Ethernet networking signal.

7. The apparatus of claim 1, wherein power is supplied to any combination of the linear transmitter, the laser diode, the photodetector, and the linear receiver via a USB connector.

8. The apparatus of claim 1, wherein power is supplied to any combination of the linear transmitter, the laser diode, the photodetector, and the linear receiver via an AC to DC power converter.

9. The apparatus of claim 1, further comprising a magnetic bead filter configured to harvest electrical power from any combination of the first electrical Ethernet networking signal and the second electrical Ethernet networking signal.

10. The apparatus of claim 1, wherein the networked device is any of a router, a switch, or a control device.

11. The apparatus of claim 1, wherein the networked device is a networked terminal.

12. The apparatus of claim 1, wherein each of the first optical communication channel and the second optical communication channel includes at least one optical fiber.

13. The apparatus of claim 12, wherein the optical fiber is a single-mode optical fiber or a multimode optical fiber.

14. The apparatus of claim 1, wherein the laser diode is any of a vertical-cavity surface-emitting laser (VCSEL), a distributed feedback (DFB) laser, a light emitting diode LED laser, a directly-modulated laser (DML), an electromagnetically modulated laser (EML), and so on.

15. A method comprising:
receiving an electrical Ethernet networking signal from a network device;
linearly amplifying the electrical Ethernet networking signal;
converting the linearly amplified electrical Ethernet networking signal into an optical Ethernet networking signal; and
transmitting the optical Ethernet networking signal over an optical communication channel.

16. The method of claim 15, wherein the linear amplification is performed by a linear amplifier.

17. The method of claim 15, wherein the converting is performed by a laser diode.

18. The method of claim 15, further comprising harvesting electrical power from the electrical Ethernet networking signal.

19. A method comprising:
receiving an optical Ethernet networking signal over an optical communication channel;
converting the optical Ethernet networking signal into an electrical Ethernet networking signal;
receiving the electrical Ethernet networking signal;
linearly amplifying the electrical Ethernet networking signal; and
transmitting the linearly amplified electrical Ethernet networking signal to a network device.

20. The method of claim 19, wherein the linear amplification is performed by a linear transimpedance amplifier.

21. The method of claim 20, wherein the linear transimpedance amplifier includes a plurality of cascaded amplifier stages.

22. The method of claim 19, wherein the converting is performed by a photodetector.

23. The method of claim 19, further comprising harvesting electrical power from the electrical Ethernet networking signal.
